(19) United States
(12) Patent Application Publication
(10) Pub. No.: US 2026/0038253 A1
(43) Pub. Date: Feb. 5, 2026

(54) MACHINE LEARNING BASED VEHICLE IMAGE VALIDATION

(71) Applicant: Yendo Inc., Dallas, TX (US)

(72) Inventors: Jordan Miller, Dallas, TX (US); Aaron Sengstacken, Westwood Hills, KS (US)

(21) Appl. No.: 19/285,783

(22) Filed: Jul. 30, 2025

Related U.S. Application Data
(60) Provisional application No. 63/677,961, filed on Jul. 31, 2024.

(51) Int. Cl. G06V 10/776; G06V 10/25; G06V 10/74; G06V 10/94; G06V 20/50

(52) U.S. Cl. CPC G06V 10/776; G06V 10/25; G06V 10/74; G06V 10/945; G06V 20/50; G06V 2201/08

(57) ABSTRACT

A system and method are provided for verifying vehicle information using image-based machine learning. A user interface is presented on a client device to guide a user in capturing and uploading images of a physical vehicle. An online system receives the images along with user-submitted vehicle data and constructs a multimodal input prompt comprising the images, metadata, and structured data templates defining expected vehicle attributes. One or more machine-learned models process the tensor to extract vehicle-related attributes, such as make, model, year, and odometer reading. The system accesses vehicle records from external databases and compares them to the extracted attributes to generate validation results. A structured data object is generated including both extracted attributes and validation outcomes, and may trigger automated workflows such as eligibility decisions, fraud checks, or vehicle valuation adjustments. The system enables scalable, real-time, and automated vehicle verification using a combination of user-captured imagery and machine learning.

### CROSS REFERENCE TO RELATED APPLICATION

This application claims the benefit of U.S. Provisional Application No. 63/677,961, filed on Jul. 31, 2024, which is hereby incorporated by reference in its entirety for all purposes.

### TECHNICAL FIELD

The present disclosure relates generally to machine learning-based vehicle data processing, and more particularly to verifying vehicle information from images using multimodal input and structured data validation.

### BACKGROUND

In the realm of online financial services, the process of securing loans against property (e.g., personal property such as vehicles) has traditionally been a complex and time-consuming endeavor. Traditional online systems rely heavily on user-reported vehicle information, such as make, model, year, condition, and ownership, which introduces significant opportunities for error, fraud, and data inconsistency. These systems often lack the technical ability to independently authenticate the content or context of submitted information. In particular, conventional computing systems are not equipped to reliably analyze user-submitted images or other information to extract structured vehicle information or detect tampering, fraud, or inconsistencies across image sets. Additionally, vehicle valuation processes typically depend on manual inspection or in-person assessment, which do not scale efficiently and are incompatible with fully digital and automated lending workflows. An automated, virtual validation process is more desirable.

### SUMMARY

In one or more embodiments, a computer-implemented method is provided for verifying vehicle information using image-based machine learning (ML). A user interface is presented on a client device to guide a user in capturing and uploading one or more images of a physical vehicle, including exterior views and a dashboard photo. The uploaded images and associated user-provided metadata are received by an online system and processed to construct a multimodal input tensor comprising the image data, structured data templates, and contextual vehicle information. The input is provided to a machine-learned model trained to extract vehicle-related attributes such as make, model, year, trim, license plate number, and odometer reading, as well as detect damage. The extracted attributes are validated against vehicle record data retrieved from one or more external databases. Based on the validation results, the system generates a structured data object and may trigger automated actions such as application approval, fraud review, or value adjustment.

### BRIEF DESCRIPTION OF THE DRAWINGS

FIG. 1A illustrates an example system environment for an online system, in accordance with one or more embodiments.

FIG. 1B is a block diagram of an online system, in accordance with one or more embodiments.

FIG. 2A illustrates a process for obtaining a structured data object as an output from a machine learning-based pipeline of an online system, in accordance with one or more embodiments.

FIG. 2B shows an example of a structured data template input to a machine learning-based pipeline of an online system, in accordance with one or more embodiments.

FIG. 2C shows an example of a structured data object output from a machine learning-based pipeline of an online system, in accordance with one or more embodiments.

FIGS. 3A-3I are example illustrations of graphical user interfaces (GUIs) provided by the online system to user devices for automatically verifying vehicle information, in accordance with one or more embodiments.

FIG. 4 is a flowchart for a method of automatically verifying vehicle information, in accordance with one or more embodiments.

FIG. 5 is a block diagram illustrating components of an example machine for reading and executing instructions from a machine-readable medium, in accordance with one or more example embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated may be employed without departing from the principles described herein.

### Configuration Overview

This disclosure pertains to an online system and method for automatically verifying vehicle information using image-based machine learning. Techniques disclosed herein look to provide a system that operates in a fully digital environment, enabling users to submit images of a vehicle—such as exterior views and dashboard photos—through a user interface on a client device. Alongside the images, users may input vehicle metadata such as a VIN or license plate number. The online system may construct a multimodal input prompt incorporating the images, user-provided metadata, and structured data templates defining expected vehicle attributes. A trained machine-learned model of the system may process this input to extract vehicle-related attributes, including make, model, year, trim, odometer reading, and visible damage.

To perform automated verification and validation, the system may access external vehicle record databases—such as the National Motor Vehicle Title Information System (NMVTIS) or state Department of Motor Vehicles (DMV)—using exposed application programming interfaces (APIs) and providing as input to the API the user-provided identifier to retrieve authoritative data about the vehicle.

A validation module of the system may compare the ML-extracted attributes with the retrieved database values, applying a set of rules to generate validation results that indicate consistency or mismatch. Using the validation results and the ML-extracted attributes, the system may generate a structured data object encoded in a machine-readable format such as JavaScript Object Notation (JSON) comprising key-value pairs for extracted vehicle attributes and validation results.

In some embodiments, the system may also perform damage analysis using the image data received from the user. The system may identify visible exterior damage regions and compute a damage severity score, confidence score, and description for each. These fields may also be included in the structured output. In some embodiments, the system may retrieve a baseline vehicle valuation from an external source (e.g., a pricing API such as Blackbook), and apply a damage adjustment model to compute an adjusted valuation.

Based on the structured output and the adjusted valuation, the system can trigger automated downstream actions, such as determining eligibility for using the vehicle as collateral, or routing the application for manual review. The system thus enables scalable, automated vehicle verification and damage analysis directly from user-captured photos—improving fraud detection, accuracy, and processing efficiency in online credit and lending workflows.

### Example System Environment

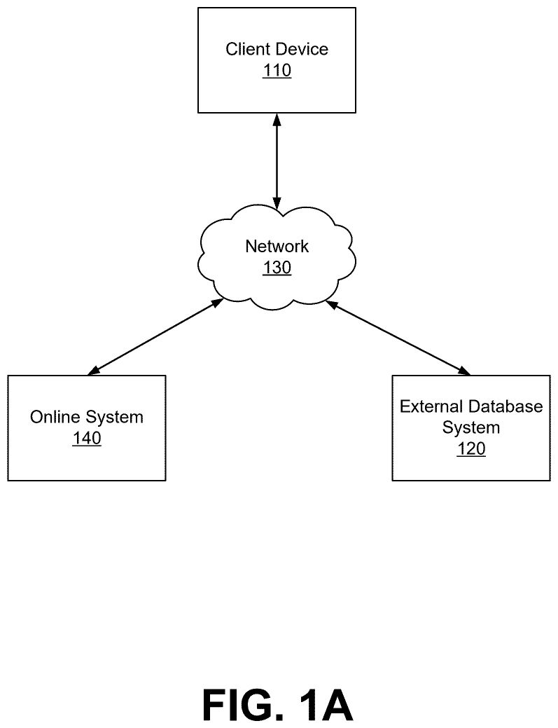

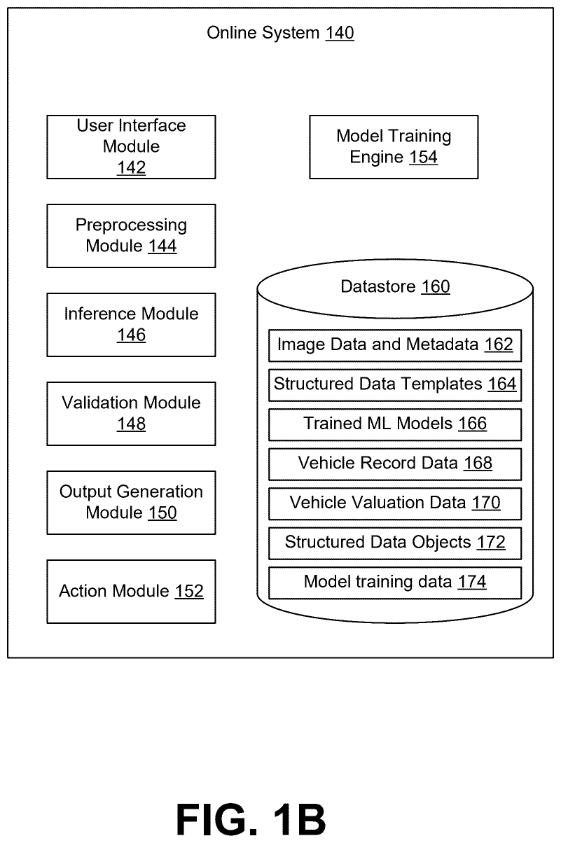

FIG. 1A illustrates an example system environment for an online system 140, in accordance with one or more embodiments. The system environment illustrated in FIG. 1A includes a client device 110, an external database system 120, network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention. While one client device 110 and one external database system 120 are illustrated in FIG. 1A, any number of client devices and external databases may interact with the online system 140. As such, there may be more than one client devices 110 or external database systems 120.

The client device 110 is a client device through which a customer may interact with the online system 140. The client device 110 can be a personal or mobile computing device, such as a smartphone, a tablet, a laptop computer, or desktop computer. In some embodiments, the customer client device 110 executes a client application that uses an application programming interface (API) to communicate with the online system 140. In some embodiments, the client device 110 may be a smartphone with an in-built camera.

In some embodiments, a customer uses the client device 110 to perform a financial transaction with the online system 140. For example, the customer may be the owner of a piece of property (e.g., real property, personal property such as a vehicle), and the financial transaction may involve the customer obtaining credit from the online system 140 in exchange of a lien on the vehicle. As another example, the financial transaction may involve the customer selling their property to an entity associated with the online system 140 in exchange of a payment or other form of consideration. As used herein, a “vehicle” can be any type of vehicle that can be used for transporting people or goods such as a passenger car, a commercial vehicle such as a truck or semi-trailer, a boat, a recreational vehicle, a motorcycle, an airplane, and the like. As used herein, “property” with respect to which the customer may enter into a financial transaction as described herein can include real property such as a house or other immovable asset, personal property such as a vehicle, a painting, a collectible item, or any other movable good that holds value.

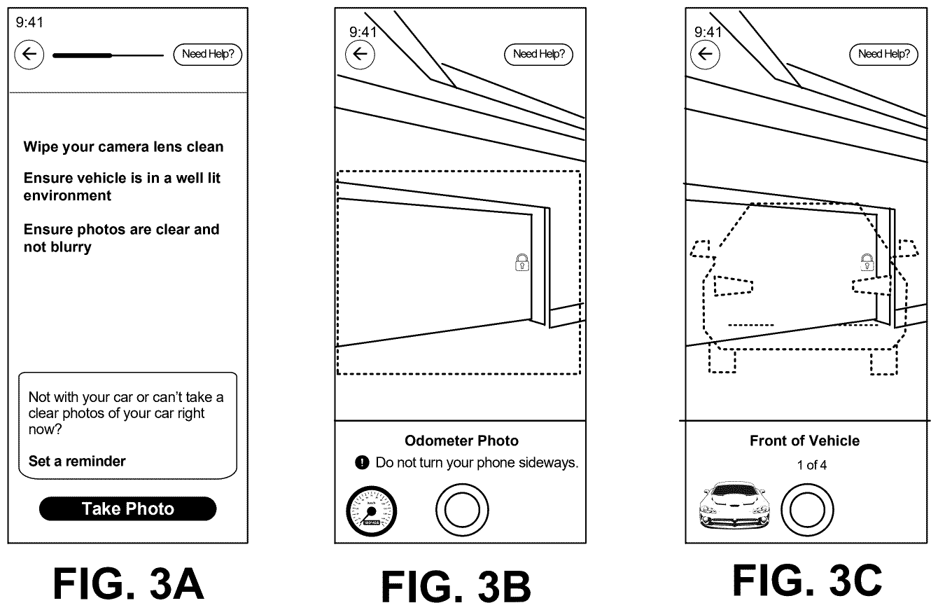

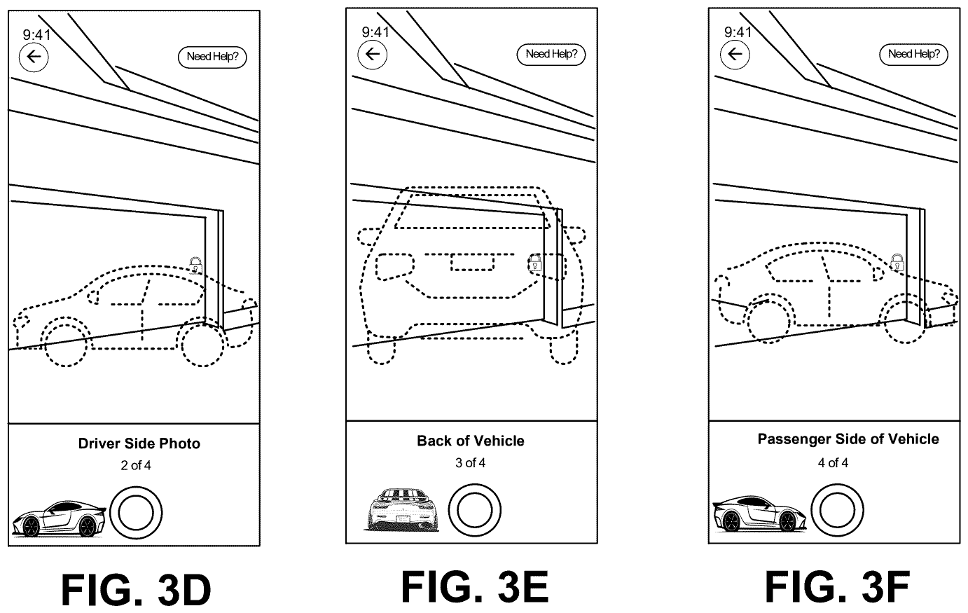

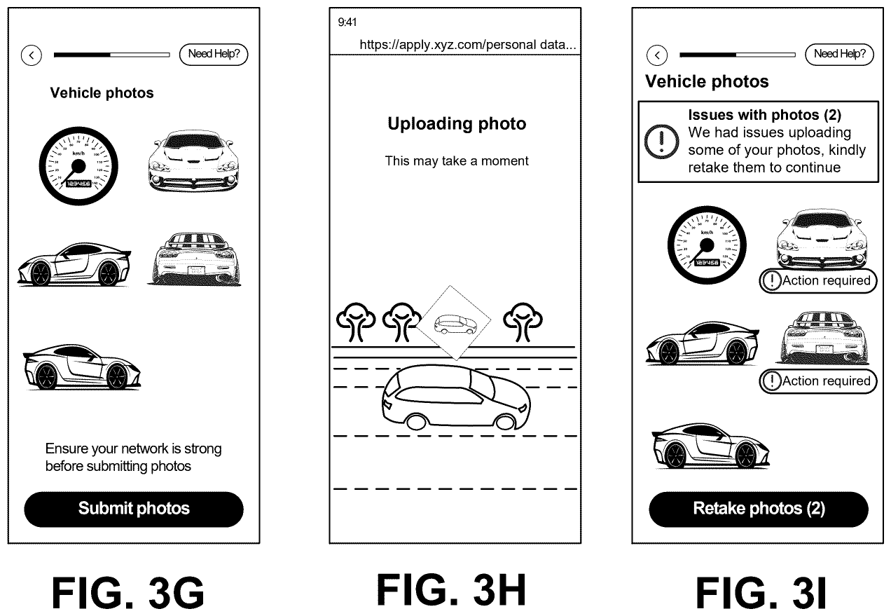

The client device 110 presents an interface to the customer. The interface is a user interface that the customer can use to interact with the online system 140. The interface may be part of an application operating on the client device 110 (e.g., application deployed by the online system 140). The interface (e.g., FIGS. 3A-3I) may allow the customer to, e.g., select a financial product such as a credit card, start a new application, input information associated with a vehicle, capture images of a vehicle using a camera of the client device 110, upload the image to the online system 140, and the like. In this context, the information associated with the vehicle may include photos or videos of the vehicle, photos or videos of vehicle ownership information associated with the vehicle, identification information of the customer, identification information associated with the vehicle. The photo or video of the vehicle may be a live photo or video captured in real-time using a camera of the client device 110. The online system 140 may also include logic to detect whether the live image is real (e.g., the image is a live image of a vehicle and not an image of another image (i.e., recaptured image). The identification information of the customer may include customer name, address, phone number, social security number, and the like. The identification information associated with the vehicle may include the license plate number, vehicle identification number (VIN), make, model, color, year, and current odometer reading.

The external database system 120 may be a state, federal, or a privately owned and operated record (e.g., National Motor Vehicle Title Information System (NMVTIS), state DMV) that allows the online system 140 to instantly and reliably obtain current title information associated with an identified vehicle in electronic form from the state that issued the title. The external database 120 may protect consumers or the online system 140 from fraud and unsafe vehicles and prevents the resale of stolen vehicles. The external database system 120 may also be an entity that provides additional indices or data points associated with a vehicle, such as title status, accident history, service history, ownership history, odometer reading history, estimated market value, and the like. Non-limiting examples of entities encompassed by the external database system 120 include Manheim Market Report, Black Book, Kelly Blue Book, JD Power, CARFAX, and the like.

In one or more embodiments, the external database system 120 may expose one or more application programming interfaces (APIs), and the online system 140 may make an API call to the external database system 120 and include identification information of a vehicle (e.g., VIN, license plate, identification information of current owner). The API of the external database system 120 may return a larger array of data points (e.g., vehicle information such as make, model, color, year, trim, odometer reading history, damage or accident history, ownership information, title information) to the online system 140. In one or more embodiments, the data received from the external database system 120 may be used as ground truth when validating the information (e.g., images of the physical vehicle, image of an odometer reading) supplied by a customer via the client device 110 to the online system 140. In some embodiments, the external database system 120 may also expose APIs that may allow the online system 140 to update information associated with a particular VIN. For example, the online system 140 may call an API of the system 120 to transmit a request to place a lien on a vehicle and provide associated information (e.g., a document signed by the owner of the vehicle, information relating to the lien holder, etc.) to the external database system 120.

In some embodiments, the external database system 120 may be an external valuation service configured to provide real-time or near-real-time vehicle valuation data in response to a programmatic request. The online system 140 may construct and transmit an application programming interface (API) call to the external valuation service, including a vehicle identifier such as a VIN or license plate number as part of the request payload. In response, the external valuation service may return a structured data payload comprising valuation-related information such as a base market value, valuation date, valuation range, mileage-based adjustments, geographic region metadata, and vehicle condition assumptions. The returned data may be encoded in a machine-readable format such as JavaScript Object Notation (JSON) or Extensible Markup Language (XML).

The client device 110, the external database system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 enables customers to enter into financial transactions based on their ownership interest in items of personal or real property, such as vehicles. The online system 140 allows a user of the client device 110 to submit an application (e.g., application for a credit card, loan, or for selling the property). As part of the application, the user may submit one or more images of the vehicle. For example, the user interface of the online system 140 executing on the client device 110 may prompt the user of the client device 110 to enable access to the camera of the client device 110 and capture in real-time, one or more pictures or videos of the exterior of the vehicle (e.g., images of the front, back and sides of the vehicle) and one or more pictures or videos of the interior of the vehicle (e.g., images of the dashboard or instrument panel of the vehicle showing the current odometer reading). The user may also submit additional information as part of the application such as one or more images of documents indicating vehicle ownership such as the current certificate of title of the vehicle, one or more images of their ID (e.g., driver's license, passport), and fill out a form including identification information of the user and of the vehicle (e.g., VIN, license plate).

Based on the submitted information—including uploaded vehicle images, user-provided metadata (e.g., VIN, license plate)—the online system 140 may perform a series of automated validation checks using trained machine-learned models and structured rule sets. The online system 140 may generate validation results by comparing extracted vehicle attributes (e.g., make, model, year, odometer, damage indicators) against ground-truth values obtained from trusted external database systems 120. The online system 140 may then orchestrate a structured data object, such as a JSON document, based on the extracted vehicle attributes and the validation results. The structured data object may include key-value pairs representing both the extracted attributes and the verification outcomes (e.g., boolean flags). The online system 140 may then automatically trigger downstream workflows based on the validation outcomes, such as initiating manual review, determining collateral eligibility, valuation adjustment or routing a user application for credit or loan processing. Additional components and processing modules of the online system 140 are described in detail below with reference to FIG. 1B.

### Example Online System

FIG. 1B is a block diagram illustrating various components of an example online system 140, in accordance with one or more embodiments. The online system 140 may include a user interface module 142, a preprocessing module 144, an inference module 146, a validation module 148, an output generation module 150, an action module 152, a model training engine 154, and a datastore 160. The datastore 160 may serve as a centralized storage system that maintains various categories of data utilized, generated, or received by the components of the online system 140 during the automated vehicle verification and processing workflows described herein. For example, the datastore 160 may store user submitted images and metadata 162, which may include raw image files captured and uploaded by users (e.g., exterior vehicle photos, dashboard photos) along with associated user-provided inputs such as VINs, license plate numbers, and odometer readings. The datastore 160 may also stores structured data templates 164, which may define the expected format, schema, and field constraints for vehicle attributes to be extracted during preprocessing and inference. The datastore 160 may further maintain trained machine-learned models 166, including serialized weights and model artifacts for different models that may be used by online system 140 for performing the automated vehicle verification and processing operations. Such models may include, e.g., a vehicle attribute extraction model, a damage detection model, and an image consistency detection model.

One or more of the machine-learned models 166 may be language models in which the sequence of input tokens or output tokens are arranged as a tensor with one or more dimensions, for example, one dimension, two dimensions, or three dimensions. In one or more embodiments, the language models are large language models (LLMs) that are trained on a large corpus of training data to generate outputs for the NLP tasks. An LLM may be trained on massive amounts of text data, often involving billions of words or text units. Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one or more embodiments, the ML models 166 may include neural networks (e.g., transformer-based neural networks), deep neural networks, convolutional neural networks, transformer neural networks, fuzzy rule matching, and the like.

In one instance, one or more of the ML models 166 may be trained and deployed or hosted on a cloud infrastructure service. The machine-learned models 166 may be pre-trained by the online system 140 using the model training engine 154 and the model training data 174, or the model training may be handled by one or more entities external to the online system 140.

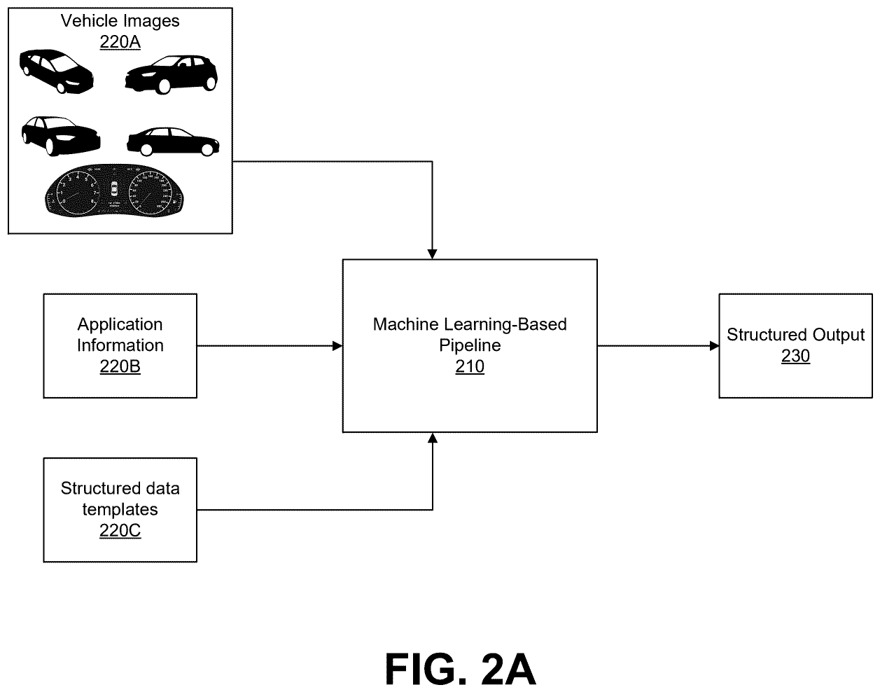

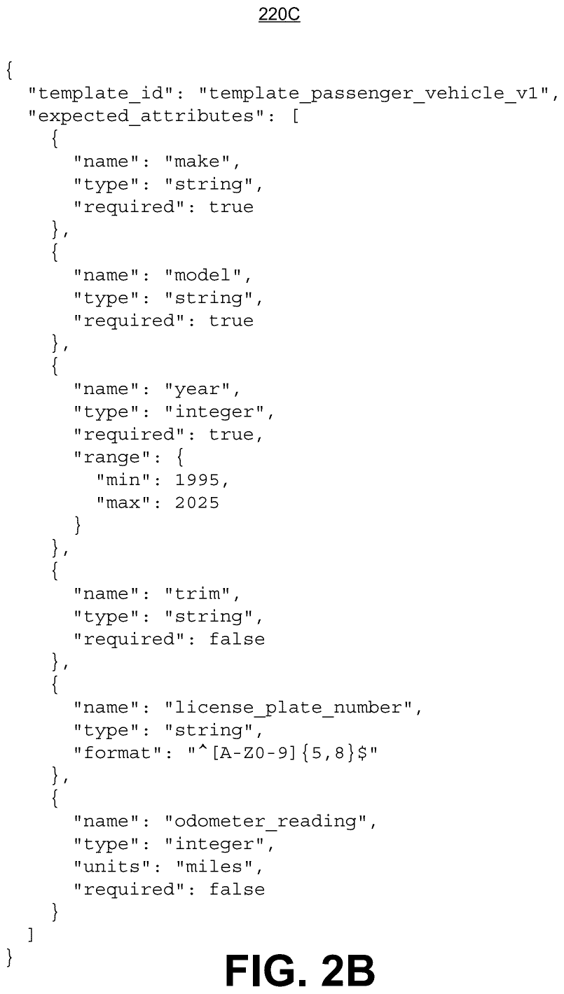

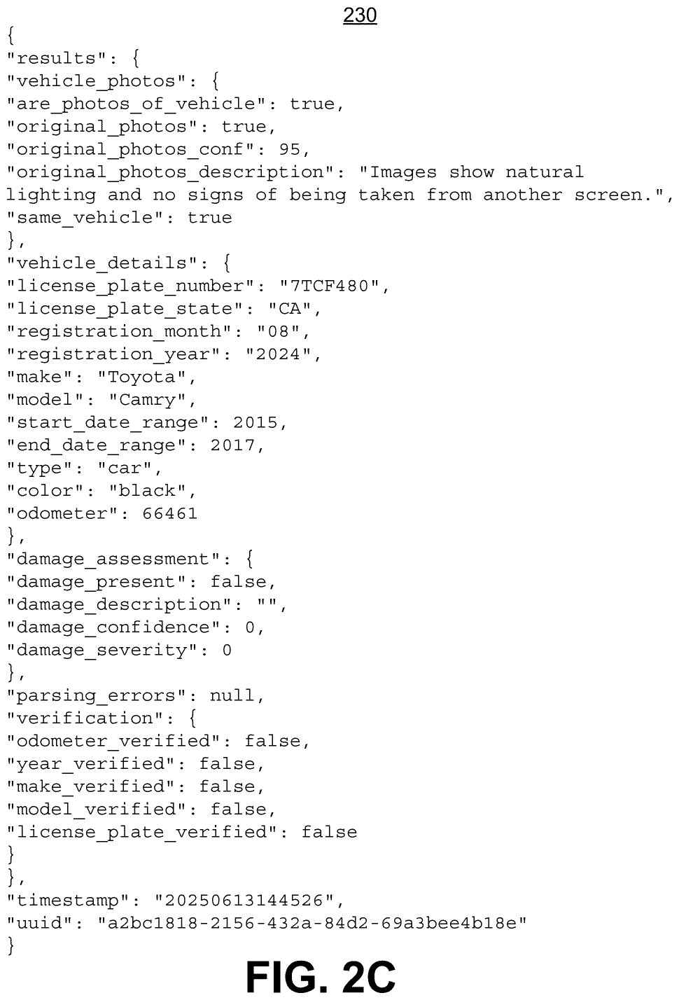

The models 166 may be trained on a large amount of data from various data sources. For example, the data sources include websites, articles, posts on the web, and the like. From this massive amount of data coupled with the computing power of the machine-learned model, the model is able to perform various tasks and synthesize and formulate output responses based on information extracted from the training data. Additional details regarding the ML models 166 their training is described below in connection with FIG. 2A.

Additionally, the datastore may contain vehicle record data 168 received from external vehicle databases (e.g., NMVTIS, DMV) and vehicle valuation data 170 retrieved from external sources (e.g., BlackBook). The datastore 160 may also archive structured data objects 172 representing the output of the ML pipeline and validation process, typically encoded in machine-readable formats such as JSON. Finally, the datastore 160 may store model training data 174, which includes labeled examples of vehicle images, ground-truth annotations, and metadata used to train and refine the ML models 166. In some embodiments, the online system 140 may include fewer or additional components. The online system 140 also may include different components. The functions of various components in the online system 140 may be distributed in a different manner than described below.

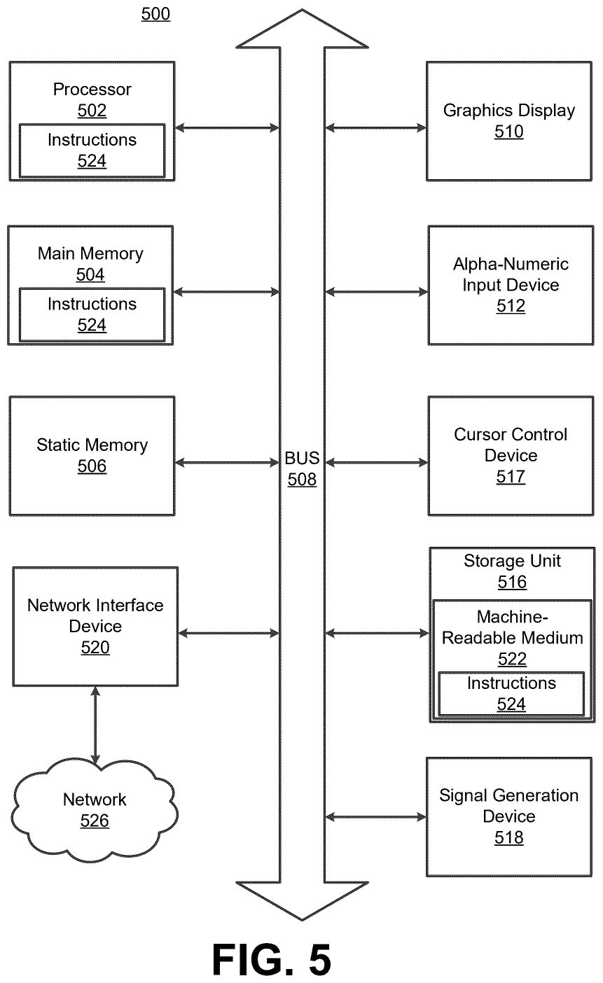

The components of the online system 140 may be embodied as software engines that include code (e.g., program code comprised of instructions, machine code, etc.) that is stored on an electronic medium (e.g., memory and/or disk) and executable by a processing system (e.g., one or more processors and/or controllers). The components also could be embodied in hardware, e.g., field-programmable gate arrays (FPGAs) and/or application-specific integrated circuits (ASICs), that may include circuits alone or circuits in combination with firmware and/or software. Each component in FIG. 1B may be a combination of software code instructions and hardware such as one or more processors that execute the code instructions to perform various processes, or a combination of both hardware and software, and may be distributed across multiple physical or virtual machines. In some embodiments, the components of online system 140 are implemented as containerized microservices, exposed via internal APIs, and executed in a cloud computing environment. Each component in FIG. 1B may include all or part of the example structure and configuration of the computing machine described in FIG. 5.

The user interface module 142 may facilitate user interaction with the online system 140 through a graphical user interface (GUI) presented on a client device 110. In some embodiments, the interface module 142 may be implemented as a mobile application developed and deployed by the online system 140 and made available for download via application distribution platforms such as the Apple App Store (for iOS devices) and Google Play Store (for Android devices). The mobile application may execute on the client device 110 and provide a native GUI for capturing and transmitting images, completing application forms, and receiving status updates from the online system 140. In other embodiments, the interface module 142 may be implemented as a web-based application accessible through a browser on the client device 110, or as part of a software-as-a-service (SaaS) platform accessed over a network (e.g., network 130 of FIG. 1A). The user interface module 142 may communicate with other components of the online system 140 using application programming interfaces (APIs), which may include RESTful endpoints, webhooks, or other communication mechanisms. Example GUIs generated by the interface module 142 are illustrated in FIGS. 3A-3I and described in further detail below.

In some embodiments, the user interface module 142 presents an image capture interface on a client device 110 that prompts the user to capture photographs of a physical vehicle, including predefined exterior and dashboard views, using the device's onboard camera. The user interface module 142 may further be configured to receive and transmit user-provided metadata—such as a vehicle identification number (VIN), license plate number, and odometer reading—along with the captured images to downstream components of the online system 140 for automated verification processing.

The preprocessing module 144 may be configured to receive the captured vehicle images and user-provided metadata (e.g., VIN, license plate number, odometer reading) and construct a multimodal input representation. In some embodiments, the preprocessing module 144 may encode the received image data and metadata into a unified tensor that may also include one or more structured data templates defining expected vehicle attributes, formats, and constraints. The multimodal input tensor may comprise structured and unstructured data aligned for inference by machine-learned models.

The inference module 146 may process the multimodal input tensor generated by the preprocessing module 144 using one or more trained machine-learned models 166 to extract vehicle-related attributes from the submitted image and metadata inputs. These attributes may include, for example, vehicle make, model, year, trim level, color, odometer reading, and visible license plate number. The inference module 146 may also apply a visual damage detection model 166 to identify and localize exterior damage regions within the submitted vehicle images, and compute corresponding damage metadata such as severity score, confidence score, and descriptive label (e.g., “dent,” “scratch”). In some embodiments, the visual damage detection model may process exterior vehicle images using a convolutional neural network (CNN) or transformer-based architecture to identify and classify regions of visible damage. The model may generate bounding boxes around damage regions, assigns each region a class label (e.g., dent, scrape, crack), compute a damage severity score based on geometric and texture features, and produce a confidence score reflecting the model's certainty in the classification. In some embodiments, the visual damage detection model may be trained using a supervised learning approach on a labeled dataset comprising exterior vehicle images annotated with bounding boxes, damage type labels, and severity scores, optimizing a multi-task loss function that combines classification, localization, and regression objectives.

The inference module 146 may further apply an image authenticity and consistency model 166 to assess whether the submitted images are original photographs of a real physical vehicle and whether the set of images are mutually consistent, i.e., correspond to the same vehicle. In some embodiments, the image authenticity and consistency model may implement a deep neural network—such as a transformer-based encoder or a multi-stream convolutional architecture—that operates on individual images as well as image sets to extract visual features indicative of recapture artifacts, compression signatures, lighting discrepancies, and vehicle identity mismatches. The model may compute one or more confidence scores indicating whether a given image is likely to be a recaptured or manipulated photo (e.g., photograph of a screen or printed image) and may also compute pairwise similarity scores between images to evaluate consistency across the set. The model output may include boolean flags or normalized confidence values that may be incorporated into the structured data object. In some embodiments, the model may be trained using curated datasets that include labeled examples of authentic and recaptured images, as well as image sets with annotated vehicle identity, using a combination of classification and contrastive loss functions to optimize prediction accuracy.

The validation module 148 may be configured to perform automated consistency checks by comparing machine-learned vehicle attribute predictions against authoritative records retrieved from one or more external vehicle databases (e.g., external database system 120). In operation, the validation module 148 may receive a set of extracted vehicle attributes from the inference module 146—including, for example, VIN, license plate number, odometer reading, and make/model/year data—and query external sources such as the National Motor Vehicle Title Information System (NMVTIS) or state Department of Motor Vehicles (DMVs) via application programming interfaces (APIs) using the user-provided identifiers. Upon receipt of a response payload containing official record data, the validation module 148 may apply a set of rule-based or learned logic operations (e.g., predetermined set of validation rules; trained ML model) to assess the consistency between the extracted attributes and the authoritative data. For example, the module 148 may check whether the license plate number corresponds to the same vehicle identity (e.g., make, model, year, VIN) as reported by the external (ground truth) source, whether the odometer reading falls within an expected range, and whether the VIN format and contents conform to manufacturer specifications. The module 148 may generate values one or more validation result fields—such as boolean flags or confidence scores—indicating the outcome of each comparison, and may associate each field with a specific reason code or mismatch explanation. In some embodiments, the validation module 148 may implement decision trees, logic graphs, or lightweight neural networks to encode and execute validation logic derived from expert-defined criteria or historical inconsistencies.

The output generation module 150 may be configured to construct a structured data object that aggregates the results of the inference and validation processes into a machine-readable representation. In some embodiments, the output generation module 150 receives as input the extracted vehicle attributes (e.g., make, model, year, trim, odometer reading, license plate number), image authenticity and consistency indicators, and damage assessment data generated by the inference module 146 (i.e., first set of key-value pairs), as well as the verification results computed by the validation module 148 (i.e., second set of key-value pairs). The module 150 may serialize this information into a structured format such as JavaScript Object Notation (JSON), with fields organized into logical sections (e.g., “vehicle,” “verification,” “damage,” “original_photos,” “same_vehicle”) that correspond to the schema defined in the structured data templates 164. Each field may be populated with a value derived from model outputs or validation flags, along with optional metadata such as confidence scores, bounding boxes, or rule match reasons. The structured data object generated by module 150 may be stored in the datastore 160 and/or transmitted to downstream components such as the action module 152 for further automated processing.

The action module 152 may be configured to determine and execute one or more automated operations based on the structured data object generated by the output generation module 150. In some embodiments, the action module 152 may evaluate fields within the structured object—such as verification flags, damage scores, image authenticity indicators, and extracted vehicle attributes—to determine whether the vehicle satisfies predefined eligibility criteria for downstream workflows. For example, the module 152 may determine that the vehicle is eligible for use as collateral if key verification fields (e.g., vin_matches_year_make_model, plate_matches, original_photos) are true and the damage severity score is below a defined threshold.

In some embodiments, in response to determining eligibility, the action module 152 may invoke an external valuation service (e.g., external database system 120) via an API call, supplying vehicle attributes such as VIN, trim, and odometer reading as request parameters. Upon receiving a valuation payload, the module 152 may optionally apply a damage adjustment model 166 to compute an adjusted collateral value based on the severity and extent of the detected damage (as indicated by corresponding damage-related attributes stored in the structured data object). The module 152 may then initiate a downstream action, such as approval of a credit application, generation of an offer, or initiation of a lien placement workflow. In some embodiments, the action module 152 may implement a rule engine or policy graph to evaluate decision criteria based on structured data fields, or may use a lightweight neural network trained on historical outcomes to optimize eligibility decisions.

The model training engine 154 may be configured to train and refine one or more machine-learned models 166 used within the online system 140, including models for vehicle attribute extraction, damage detection and scoring, image authenticity and consistency assessment, and validation rule classification. In some embodiments, the model training engine 154 may access labeled training data 174 stored in the datastore 160, including annotated vehicle images, user-provided metadata (e.g., VINs, odometer readings), and structured data templates that define the expected attribute schema. For each training example, the engine 154 may generate input tensors comprising multimodal data—such as pixel data from vehicle photographs, tokenized VIN or plate metadata, and embedding vectors for structured templates—paired with ground-truth output labels (e.g., vehicle make, model, year, trim, damage region bounding boxes, damage severity scores, image authenticity flags, and validation results).

In some embodiments, the model training engine 154 may apply supervised learning techniques using a combination of classification, regression, and detection losses, including cross-entropy loss for categorical attributes, smooth L1 loss for bounding box regression, focal loss for damage region detection, and contrastive loss for image consistency modeling. Optimization may be performed using stochastic gradient descent (SGD), Adam, or other gradient-based methods across batched input tensors, optionally using GPU-accelerated infrastructure in a cloud-based environment. The engine 154 may periodically retrain deployed models using new edge-case examples harvested from live system traffic or manual annotation workflows. In some embodiments, training may be initiated automatically in response to detection of drift in model performance metrics or manually triggered by an operator through an administrative interface.

### Example Machine-Learning-Based Data Extraction and Validation Pipeline

FIG. 2A describes an example ML-based vehicle verification pipeline 210 that can be implemented by the online system 140. A subset of the components of the online system 140 shown in FIG. 1B may define the machine-learning-based vehicle verification pipeline 210 configured to perform various data extraction and validation operations based on the information submitted by the user of the client device 110 as well as based on data received from one or more external database systems 120. In one or more embodiments, the ML-based vehicle verification and valuation pipeline 210 may include one or more machine-learned models 166, the preprocessing module 144, the inference module 146, the validation module 148, and the output generation module 150 to extract and validate vehicle information based on the input provided by the user and based on external (ground truth) data.

FIG. 2A shows that the pipeline 210 may be configured to generate a structured output 230 (i.e., structured data object 172; hierarchical data structure) that includes sections on information about the vehicle, information about any damage to the vehicle and corresponding damage metrics, information about the license plate, information about the odometer reading, and validation and verification section indicating if there are any discrepancies or “red flags” in the submitted information, based on the output of the ML models 166 and the data received from the external databases 120.

FIG. 2A shows that the model(s) 166 of the pipeline 210 may be configured to accept a multimodal input (e.g., tensor generated by the preprocessing module 144) including the vehicle images 220A, user-submitted information (e.g., in text form) 220B, and structured data templates 220C. More specifically, as shown in FIG. 2A, the input to the models 166 of the pipeline 210 may include a plurality of images 220A. The images may be captured by the customer in real-time using a camera of the client device 110. The images may be of the exterior of a physical vehicle of the customer and an image of a dashboard of the vehicle that shows the instrument cluster of the vehicle, the current odometer reading, and the like. The input may further include application information 220B provided by the customer via the user interface. For example, the application information may include identification information of the vehicle (e.g., VIN, license plate number), identification information of the customer, financial products the customer is interested in, and the like.

The one or more structured data templates 220C may define the expected schema, format constraints, and semantic rules for vehicle-related data fields to be extracted and validated. The templates 220C may be implemented as structured, machine-readable objects (e.g., JSON) and may include, for each expected attribute, metadata indicating the field name, data type (e.g., string, integer), whether the field is required or optional, permitted value ranges or regular expression patterns, and any applicable units or format hints. During inference, the structured data templates 220C may be combined with image and metadata inputs to form a multimodal tensor that is input to the machine-learned models 166. By embedding these templates in the input representation, the system constrains the output space of the model and aligns its predictions with a predefined schema, thereby improving extraction accuracy, reducing ambiguity, and facilitating validation downstream. These templates may also enable dynamic configuration of model behavior for different vehicle types, use cases, or jurisdictions.

Thus, the structured data templates 220C indicate examples of the type of data the machine-learned model 166 of the pipeline 210 should detect from the input image data 220A. For example, the structured data templates 220C may include image examples of license plates for the model to detect a license plate in the input images. As another example, the structured data templates 220C may include image examples of a particular make, model, year, and trim of a vehicle, and image examples of what the dashboard for such a type of vehicle looks like (e.g., the shape, size, design, coloration, or number of instruments in the instrument cluster of the dashboard).

A specific example of a structured data template 220C is shown in FIG. 2B. The example template 220C specifies a schema for processing standard passenger vehicles. As shown, the template includes an array of expected_attributes, each describing an attribute that the model 166 is expected to extract from input images. For example, the attributes “make,” “model,” and “year” are all marked as required, with “year” constrained to be an integer value between 1995 and 2025. The “license_plate_number” field is defined as a string matching a regular expression pattern that limits it to between 5 and 8 alphanumeric characters. The “odometer_reading” attribute is defined as an integer and includes a units field set to “miles.” By codifying these expectations in a structured format, the system can enforce consistency across data sources and ensure that each extracted field conforms to the appropriate data type, range, and structure.

The exemplary structured data template 220C of FIG. 2B also supports optional fields (e.g., “trim” and “odometer_reading”) and allows for format-aware validation based on domain-specific knowledge. For instance, by incorporating a regex pattern for license plate numbers or range constraints for production years, the template enables both the inference module 146 and validation module 148 to reject or flag candidate extractions that fall outside plausible bounds. In some embodiments, these templates 220C may be version-controlled and centrally managed by the system 140, allowing administrators to modify or extend attribute definitions as needed without retraining the underlying models 166. This design supports adaptability to evolving vehicle formats, localization for state-specific formats, and fine-grained tuning of pipeline 210 behavior, all while producing normalized structured outputs that conform to the predefined schema.

The model 166 of the pipeline 210 may be configured to determine, based on the input templates 220C and the input images 220A, whether the images 220A input to the model 166 are of the same type of vehicle and whether the dashboard image 220A input to the model is of the same type of vehicle. The structured data templates 220C help guide the model output and improve performance. In some embodiments, instead of inputting the examples 220C to the model, the pipeline 210 may include custom models trained using historical labeled image data of different types of vehicles and historical labeled image data of dashboards of the different types of vehicles. In one or more embodiments, the information provided by the external database system 120 may also be input to the ML-based pipeline 210. The models of the pipeline 210 may utilize this information for, e.g., validation, and include it in the structured output 230.

In one or more embodiments, the machine-learned model 166 of the pipeline 210 for detecting the type of vehicle (e.g., make, model, year, trim) based on the input image data 220A may be a generative AI model (e.g., LLM, or a foundational model) that can accept the multimodal input to determine the type of vehicle that is captured in the image data 220A. Based on the output of the model, the pipeline 210 may verify whether all of the images 220A, including the image 220A of the dashboard, belong to the same vehicle, and whether the type of vehicle detected based on the image 220A of the dashboard input by customer matches with the type of vehicle identified in the external database for the license plate number or VIN provided by the customer as the application information 220B.

Further, based on data received from the external database system 120 for the vehicle identifier 220B provided by the customer, the pipeline 210 may verify whether the images 220A provided by the customer are of the same type of vehicle (e.g., make, year, model, trim) as the vehicle described in the dataset received in response to the API call to the external database system 120.

The pipeline 210 may also include a model 166 to perform license plate verification. The model 166 may be configured to detect a region of the input image 220A that includes the license plate and provide a crop of the detected region to an OCR model to detect the license plate number in the input image 220A. In some embodiments, the instead of utilizing an OCR model, the pipeline 210 may include models that are able to directly extract the license plate number from the input image. Further, based on the dataset received in response to the API call to the external database system 120, the verification module of the pipeline 210 may determine whether the license plate number in the external database matches the number extracted from the image 220A, whether the vehicle type corresponding to the license plate number in the external database matches the vehicle type detected in the image 220A, whether the VIN associated with the license plate number in the external database matches the VIN provided by the customer as the application information 220B.

Odometer validation performed by the pipeline 210 may include applying an OCR model to the verified input image 220A of the dashboard to obtain the current odometer reading and comparing the extracted mileage with the mileage provided by the customer on the application form 220B and the odometer reading history reported by the external database system 120 and flagging any discrepancies in the structured output 230.

The pipeline 210 may also perform registration sticker validation. In one or more embodiments, the pipeline 210 may include a model 166 configured to detect whether the input image 220A includes a registration sticker and provide a crop of the sticker to a model (e.g., OCR model) to detect the registration expiration date, the year of registration (e.g., based on a detected color of the sticker), and/or the registration state. The registration information detected by the pipeline 210 may be included as part of the structured output 230.

In one or more embodiments, the pipeline 210 may include machine-learned models 166 configured to take the verified images 220A of the exterior of the vehicle as input and assess the images for damage to the vehicle. In one or more embodiments, the model may be trained using historical labeled image datasets to score the damage based on severity (e.g., on a scale of 0 to 10). The model may be configured to output the damage assessment score and further output an explanation for the assessed score (e.g., a portion of the image based on which the score was assigned). The model may also output a confidence score indicating the confidence of the model in the assessed value for the damage score.

The models 166 of the pipeline 210 may be configured to simultaneously accept the multimodal input 220 and perform the above-described verification functions to confirm that, e.g., the input photos of the exterior of the car are genuine and match the license plate or VIN provided by the applicant, the input dashboard photo of the car is genuine and matches the license plate or VIN provided by the applicant, there is no significant damage to the car or that the car is in drivable condition, the license plate of the car matches the license plate number provided by the applicant, and the like. The output 230 from the pipeline 210 is structured as, e.g., a JSON object that can be return to another system in an API call or populate a database as a record (e.g., archive in datastore 160 as data 172). Any machine-learned model 166 or combination of models 166 may be included in the ML-based pipeline 210 to generate and validate the structured output 230 based on the input 220.

FIG. 2C illustrates an example structured output 230 generated by the ML-based pipeline 210 of the online system 140, based on the images and metadata submitted by the user via the user interface module 142 and the processing performed by the preprocessing module 144, inference module 146, validation module 148, and output generation module 150. The structured output 230 may be encoded in a machine-readable format, such as a JSON (JavaScript Object Notation) object, and may include key-value pairs representing extracted vehicle-related attributes, damage assessment results, validation outcomes, and metadata. In some embodiments, the structured output 230 may be archived in the datastore 160 as part of structured data objects 172 for downstream processing, exception handling, or auditability.

In the example shown in FIG. 2C, the structured output includes a vehicle_details (e.g., first set of key-value pairs) section populated by the inference module 146, which uses machine-learned models 166 to extract information such as license plate number, vehicle make, model, color, and odometer reading. The damage_assessment section (e.g., first set of key-value pairs) includes fields generated by the visual damage detection model, including a boolean flag indicating whether damage is present, a textual damage description, and numerical confidence and severity scores. The object 230 may include such a damage_assessment section for each of one or more regions where damage is detected on the vehicle. Similarly, the vehicle_photos (e.g., first set of key-value pairs) section includes results from the image authenticity and consistency model, which analyzes the uploaded images for originality and internal consistency across views. These determinations may be output and included in the object 230 as boolean and confidence-valued fields that reflect whether the images likely depict a real, unmanipulated vehicle.

The verification section (e.g., second set of key-value pairs) in the object 230 reflects results produced by the validation module 148, which compares the extracted attributes to vehicle record data retrieved from external database systems 120 (e.g., NMVTIS or state DMV APIs). The validation module 148 may determine whether specific fields such as odometer, year, make, model, and license plate match external ground truth data, and encode the result of each comparison as a boolean flag. These outputs, along with any parsing_errors, may be aggregated by the output generation module 150 as implemented by the pipeline 210 to form the final structured data object 230.

As explained previously, the object 230 may then be used by the action module 152 to trigger automated workflows—such as collateral eligibility checks or fraud review routing—and may also be stored in datastore 160 as data 172 for subsequent review or reprocessing in light of updated user submissions or new external records. For example, an automated workflow performed by the action module 152 may include accepting the customer's application, rejecting the application, adjusting a credit limit for the customer based on vehicle valuation, and the like. Below are some non-limiting examples of the process flow of the online system 140 based on the output of the ML-based pipeline 210.

In one or more embodiments, the action module 152 may utilize the object 230 and an external database to assess a value of the vehicle that has been verified by the system 140. For example, based on the verified vehicle information (e.g., license plate, VIN, make, model, year, trim), the action module 152 may make an API call to an external database system 120 to obtain a fair market value of the vehicle, and further adjust the value based on the verified mileage and location of the applicant. The action module 152 may further include logic to adjust the market value based on the additional datapoints obtained from the external databases such as autocheck history, accident history, recall information, and the like. The action module 152 may also include logic to adjust down the assessed value of the vehicle based on attribute values in the data object 230 related to damage assessment (e.g., adjust the value down if the front bumper is severely damaged, reject application for credit is the car is determined to be totaled or not in drivable condition by the damage assessment model).

The structured output 230 from the ML-based pipeline 210 may also be used for other applications. For example, the information may be used to determine whether a valid lien can be placed on the vehicle and credit issued to the customer and set the credit limit. As another example, the information may be used as part of a process to determine the value of the vehicle to be able to transact (e.g., purchase) the vehicle from the customer. As yet another example, the output of the pipeline 210 may be provided (e.g., via an API, or as a database entry) to a third party who may use this information to, e.g., automate an existing workflow. For example, a used car retailer, auction, or salvage company, may outsource the data extraction and validation steps when buying used cars from customers by providing the image data and customer information 220 to the online system 140, and receiving in real-time and automatically, the structured data 230 from the online system 140.

### Example Graphical User Interfaces

FIGS. 3A through 3I illustrate example graphical user interfaces (GUIs) generated by the user interface module 142 of the online system 140 and presented on a client device 110 to guide a user through a structured vehicle photo capture and verification workflow, in accordance with one or more embodiments. These GUIs may be implemented in a native mobile application or mobile web interface and are configured to assist the user in capturing images of the physical vehicle for use in the ML-based pipeline 210 described with reference to FIG. 2A.

FIG. 3A depicts an initial GUI presented by the user interface module 142 prompting the user to begin capturing required images of the vehicle. The interface may include instructional text and interactive elements (e.g., “Start Capturing Photos”) that trigger the device camera and initiate the image capture workflow.

FIG. 3B illustrates a live camera interface in which the application overlays a framing guide in the form of a rectangular outline with broken lines. The prompt instructs the user to align and capture an image of the vehicle dashboard such that the odometer panel is within the guide. A thumbnail image is shown near the capture button, providing a visual example of a properly framed dashboard image. This framing interface is dynamically rendered by the user interface module 142 based on the type of image requested in the workflow.

Upon successfully capturing the dashboard image, the user interface transitions to the next GUI, illustrated in FIG. 3C. This GUI prompts the user to capture the front exterior of the vehicle. Similar to FIG. 3B, an overlay in broken lines corresponding to the silhouette of the front of a vehicle is displayed on the screen to help the user correctly position the camera. The prompt at the bottom provides contextual instructions, and a thumbnail image is provided as a reference for correct framing.

FIGS. 3D through 3F repeat the guided capture interface for the remaining required images: the driver side (FIG. 3D), the rear (FIG. 3E), and the passenger side (FIG. 3F) of the vehicle. Each screen includes a context-appropriate outline overlaid on the live camera view, an instructional prompt, and an example thumbnail to ensure consistency and quality across the captured dataset. These screens are dynamically rendered and sequenced by the user interface module 142 in accordance with a predefined image capture flow.

FIG. 3G shows a post-capture review screen that displays thumbnails of all five captured images (e.g., odometer, front, left, right and rear perspectives). The interface prompts the user to either proceed with submitting the captured images to the server or return to any step to retake an image. Once the user confirms, the images are transmitted from the client device 110 to the online system 140, where they are stored in datastore 160 and processed by the ML-based pipeline 210.

FIG. 3H illustrates a GUI screen indicating that the captured photos are being uploaded to the server. This screen may be shown while the online system 140 receives the image data and begins executing preprocessing and validation operations. FIG. 3I illustrates an error resolution screen displayed if one or more of the uploaded images are rejected by the online system 140. In the depicted embodiment, two images have been flagged as invalid—for example, due to poor lighting, incorrect framing, or inconsistency with structured data templates 220C. The rejected images may be visually identified in the interface and accompanied by specific prompts explaining the issues and instructing the user on how to correct them (e.g., “Reframe the front view to include the full bumper”). This feedback may be based on outputs of the inference module 146 or validation module 148, including confidence scores, authenticity scores, and bounding box metadata.

Collectively, FIGS. 3A through 3I illustrate an adaptive and interactive frontend experience that supports high-fidelity image acquisition and guides the user through a compliant submission flow. The online system 140 leverages these interfaces to capture high-quality input for its automated verification pipeline and provides real-time validation feedback to minimize failure rates and ensure data integrity.

### Example Process

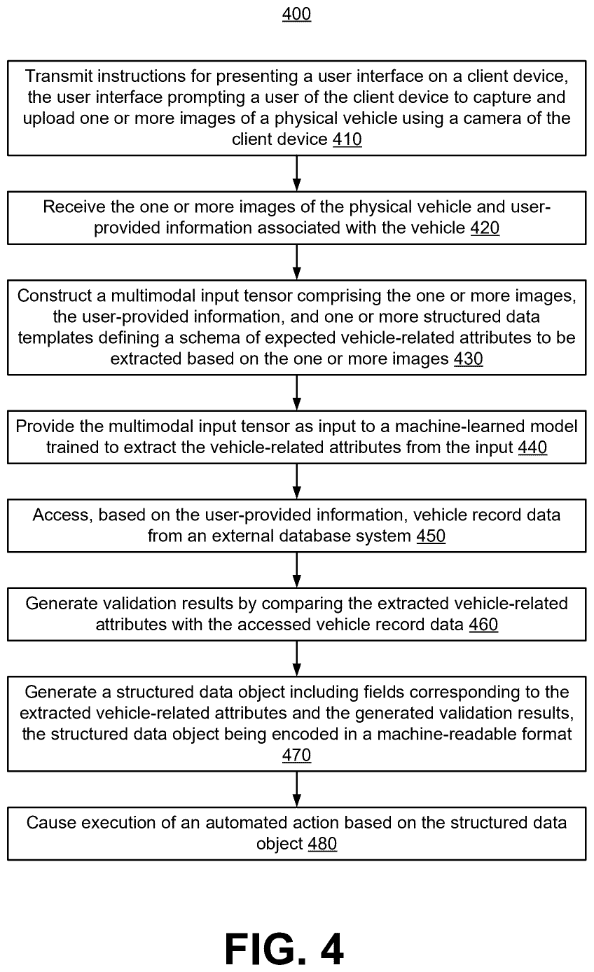

FIG. 4 is a flowchart illustrating a computer-implemented method 400 for verifying vehicle information using image-based machine learning, in accordance with one or more embodiments. The method 400 may be performed by the online system 140 described with reference to FIGS. 1B and 2A-2C. The method 400 may be implemented as a sequence of software-implemented operations executed by functional components of the online system 140, including but not limited to the user interface module 142, preprocessing module 144, inference module 146, validation module 148, output generation module 150, action module 152, and machine-learned models 166, with support from structured data stored in datastore 160. Unless otherwise stated, each step may be performed automatically by the system without human intervention.

At step 410, the online system 140 transmits instructions for presenting a user interface on a client device 110. These instructions may be executed by a mobile application or browser-based interface, which presents a sequence of GUIs (e.g., FIGS. 3A-3I) designed to guide the user through capturing photographs of a physical vehicle. The user interface may be rendered and managed by the user interface module 142 and may include image framing guides, capture prompts, example thumbnails, and error correction flows. In one or more embodiments, the interface prompts the user to capture a set of standardized photos including the dashboard, front, rear, and side views of the vehicle, using the onboard camera of the client device 110.

At step 420, the online system 140 receives one or more images of the physical vehicle and user-provided information associated with the vehicle. These may be received as a bundled data submission and may be transmitted over secure network channels to backend endpoints hosted by the online system 140. The user-provided information may include, for example, a license plate number, VIN, odometer reading, vehicle registration details, or intended use of the vehicle (e.g., loan application, sale, insurance verification). These data assets may be stored in the datastore 160 in association with a session token, user identifier, or application record.

At step 430, the preprocessing module 144 constructs a multimodal input tensor. The tensor is generated from the received image data, user-provided metadata, and one or more structured data templates 220C, such as the template shown in FIG. 2B. These structured templates define a schema of expected vehicle-related attributes, including required and optional fields (e.g., make, model, year, trim, odometer, license plate), associated constraints (e.g., value ranges, regex patterns), and units (e.g., miles). The multimodal input tensor encodes visual data from the vehicle images, metadata input by the user, and schema-guided structural priors, and serves as the input to downstream machine-learned models. In one or more embodiments, the preprocessing may include image normalization, resizing, and conversion to a format compatible with transformer-based vision-language architectures.

At step 440, the inference module 146 provides the multimodal input tensor to one or more machine-learned models 166 trained to extract structured vehicle-related attributes. The machine-learned models 166 may include specialized submodels for dashboard odometer recognition, license plate detection, vehicle orientation analysis, image authenticity verification, and vehicle type classification. These models may operate on fused representations of image content and schema-level priors to output semantically tagged, field-aligned values (e.g., “model”: “Camry”, “year”: 2016). The models may further produce confidence scores, bounding boxes, and image quality diagnostics to guide downstream validation.

At step 450, the validation module 148 accesses vehicle record data from one or more external database systems 120. These external systems may include state DMV APIs, the National Motor Vehicle Title Information System (NMVTIS), vehicle history providers (e.g., Carfax), or commercial valuation engines (e.g., Blackbook). The access may be performed by generating one or more API requests using identifiers from the user-provided information (e.g., license plate number or VIN). The retrieved vehicle record data may include authoritative values for make, model, trim, year, odometer history, registration state, and accident history, which are used as ground truth for validation purposes.

At step 460, the validation module 148 compares the extracted vehicle-related attributes (from step 440) with the external ground truth data (from step 450) to generate validation results. These results may include binary match/mismatch flags, probabilistic match scores, and explanations (e.g., “odometer reading appears inconsistent with prior record”). Validation logic may include string similarity measures, range checks, unit normalization, VIN format validation (e.g., check digit), and fuzzy matching across attribute types. The system may also detect inconsistencies or anomalies, such as misaligned make/model-year combinations, mismatched license plate states, or images inconsistent with declared vehicle type.

At step 470, the output generation module 150 produces a structured data object 230 (e.g., FIG. 2C) that includes fields corresponding to the extracted attributes and associated validation results. The structured data object may be encoded in a machine-readable format such as JSON and include nested sections for vehicle details, photo authenticity, damage assessment, and verification results. Each field may be annotated with confidence scores, bounding box metadata, parsing errors (if any), and validation flags. The structured output may be stored in the datastore 160 as structured data object 172 and may be available for downstream consumption by automated workflows or human review.

At step 480, the action module 152 executes one or more automated actions based on the contents of the structured data object. These actions may include accepting or rejecting a loan application, initiating a title or lien verification process, triggering fraud review workflows, adjusting a valuation of the vehicle, or prompting the user to resubmit missing or invalid images. In some embodiments, the structured data object may be transmitted to external systems via APIs, archived for compliance auditing, or used to trigger auxiliary processes such as messaging, escalation, or customer support routing. The system may also update user records with validated vehicle information to support future transactions or interactions. Method 400 thus implements an end-to-end machine learning pipeline for automated vehicle information verification, combining multimodal machine learning with schema-guided inference and external data validation to enable robust, real-time decisioning in digital vehicle transactions.

### Example Computer System

FIG. 5 is a block diagram illustrating components of an example machine for reading and executing instructions from a non-transitory machine-readable medium, in accordance with one or more example embodiments. Specifically, FIG. 5 shows a diagrammatic representation of one or more of the online system 140, the user devices 110, and the machine for performing the process 400 of FIG. 4 in the example form of a computer system 500.

The computer system 500 can be used to execute instructions 524 (e.g., program code or software) for causing the machine to perform any one or more of the methodologies (or processes) or modules described herein. In alternative embodiments, the machine operates as a standalone device or a connected (e.g., networked) device that connects to other machines. In a networked deployment, the machine may operate in the capacity of a server machine or a client machine in a client-server network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes one or more processing units (generally processor 502). The processor 502 may include, for example, a central processing unit (CPU), a graphics processing unit (GPU), a digital signal processor (DSP), a control system, a state machine, one or more application-specific integrated circuits (ASICs), one or more radio-frequency integrated circuits (RFICs), or any combination of these. The computer system 500 also includes a main memory 504. The computer system 500 may further include a storage unit 516. The processor 502, memory 504, and the storage unit 516 communicate via a bus 508.

In addition, the computer system 500 may include a static memory 506, a graphics display 510 (e.g., to drive a plasma display panel (PDP), a liquid crystal display (LCD), or a projector). The computer system 500 may also include an alphanumeric input device 512 (e.g., a keyboard), a cursor control device 517 (e.g., a mouse, a trackball, a joystick, a motion sensor, or other pointing instrument), a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. For example, the instructions 524 may include the functionalities of modules of one or more of the online system 140, or user computing devices 110 of FIG. 1A, and the machine for performing the process 400 of FIG. 4. The instructions 524 may also reside, completely or at least partially, within the main memory 504 or within the processor 502 (e.g., within a processor's cache memory) during execution thereof by the computer system 500. The main memory 504 and the processor 502 also constitute machine-readable media. The instructions 524 may be transmitted or received over a network 526 via the network interface device 520.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method for verifying vehicle information using image-based machine learning, the method comprising:
transmitting, by an online system, instructions for presenting a user interface on a client device, the user interface prompting a user of the client device to capture and upload one or more images of a physical vehicle using a camera of the client device;
receiving, at the online system, the one or more images of the physical vehicle and user-provided information associated with the vehicle;
constructing, by a preprocessing module of the online system, a multimodal input tensor comprising the one or more images, the user-provided information, and one or more structured data templates defining a schema of expected vehicle-related attributes to be extracted based on the one or more images;
providing the multimodal input tensor as input to a machine-learned model trained to extract the vehicle-related attributes from the input;
accessing, based on the user-provided information, vehicle record data from an external database system;
generating validation results by comparing the extracted vehicle-related attributes with the accessed vehicle record data;
generating a structured data object including fields corresponding to the extracted vehicle-related attributes and the generated validation results, the structured data object being encoded in a machine-readable format; and
causing execution of an automated action based on the structured data object.

2. The computer-implemented method of claim 1, wherein providing the multimodal input tensor as input to the machine-learned model trained to extract the vehicle-related attributes comprises:
detecting, based on the one or more images, one or more of: a license plate number, a vehicle make, a vehicle model, a vehicle color, a vehicle year, a vehicle trim, or an odometer reading;
determining whether the one or more images are original photos of a real vehicle and whether the images are consistent with one another as depicting the same vehicle; and
performing a visual damage assessment based on the one or more images.

3. The computer-implemented method of claim 2, wherein performing the visual damage assessment based on the one or more images comprises:
identifying, using the machine-learned model, one or more regions within the one or more images that correspond to potential damage on exterior surfaces of the vehicle; and
generating, for each identified region, a damage severity score, a damage confidence score, and a damage description, wherein the vehicle-related attributes in the structured data object include the damage severity score, the damage confidence score, and the damage description for each identified region.

4. The computer-implemented method of claim 3, wherein causing execution of the automated action based on the structured data object comprises:
obtaining, from an external valuation service, a vehicle valuation based on a vehicle identifier included in the structured data object;
applying a damage adjustment model to the vehicle valuation based on one or more of: the damage severity score, the damage confidence score, or a number of identified damage regions; and
determining, based on an adjusted valuation output from the damage adjustment model, whether the vehicle satisfies a collateral condition.

5. The computer-implemented method of claim 1, wherein the user-provided information includes a vehicle identifier, and wherein accessing, based on the user-provided information, vehicle record data from the external database system comprises:
generating an application programming interface (API) request that includes the vehicle identifier;
transmitting the API request to the external database system; and
receiving, in response to the API request, an API payload comprising the vehicle record data that includes one or more vehicle-related attributes corresponding to the vehicle identifier.

6. The computer-implemented method of claim 1, wherein generating the validation results by comparing the extracted vehicle-related attributes with the accessed vehicle record data comprises:
comparing an extracted vehicle-related attribute with a corresponding attribute in the accessed vehicle record data;
determining, based on the comparison and a predetermined set of validation rules, whether the extracted attribute is consistent with the corresponding attribute in the vehicle record data;
generating a boolean verification flag based on a result of the determination; and
including the boolean verification flag as a validation attribute in the structured data object.

7. The computer-implemented method of claim 1, wherein the structured data object is a hierarchical data structure comprising:
a first set of key-value pairs corresponding to the vehicle-related attributes extracted by the machine-learned model, the vehicle-related attributes including one or more of: a license plate number, a vehicle make, a vehicle model, a vehicle year range, a vehicle color, an odometer reading, a damage severity score, or a damage confidence score; and
a second set of key-value pairs corresponding to the generated validation results, each key-value pair in the second set representing a boolean verification flag generated based on a comparison between a corresponding value in the first set and the accessed vehicle record data.

8. The computer-implemented method of claim 1, wherein the one or more images of the physical vehicle comprise:
a plurality of exterior images of the vehicle captured from front, rear, left, or right perspectives; and
an interior image of a vehicle dashboard including an odometer display.

9. The computer-implemented method of claim 1, wherein causing execution of the automated action based on the structured data object comprises:
determining whether the vehicle satisfies eligibility criteria for use as a collateral based on one or more attributes included in the structured data object; and
triggering an approval or rejection workflow based on the determination.

10. The computer-implemented method of claim 1, wherein causing execution of the automated action based on the structured data object comprises:
determining, based on the validation results, a mismatch between an extracted vehicle-related attribute and the vehicle record data; and
automatically triggering a rejection workflow based on the determination.

11. A non-transitory computer-readable storage medium storing executable instructions that, when executed by a hardware processor of an online system, cause the hardware processor to perform steps comprising:
transmitting instructions for presenting a user interface on a client device, the user interface prompting a user of the client device to capture and upload one or more images of a physical vehicle using a camera of the client device;
receiving the one or more images of the physical vehicle and user-provided information associated with the vehicle;
constructing a multimodal input tensor comprising the one or more images, the user-provided information, and one or more structured data templates defining a schema of expected vehicle-related attributes to be extracted based on the one or more images;
providing the multimodal input tensor as input to a machine-learned model trained to extract the vehicle-related attributes from the input;
accessing, based on the user-provided information, vehicle record data from an external database system;
generating validation results by comparing the extracted vehicle-related attributes with the accessed vehicle record data;
generating a structured data object including fields corresponding to the extracted vehicle-related attributes and the generated validation results, the structured data object being encoded in a machine-readable format; and
causing execution of an automated action based on the structured data object.

12. The non-transitory computer-readable storage medium of claim 11, wherein the instructions that cause the hardware processor to provide the multimodal input tensor as input to the machine-learned model trained to extract the vehicle-related attributes comprise instructions that cause the hardware processor to perform steps comprising:
detecting, based on the one or more images, one or more of: a license plate number, a vehicle make, a vehicle model, a vehicle color, a vehicle year, a vehicle trim, or an odometer reading;
determining whether the one or more images are original photos of a real vehicle and whether the images are consistent with one another as depicting the same vehicle; and
performing a visual damage assessment based on the one or more images.

13. The non-transitory computer-readable storage medium of claim 12, wherein the instructions that cause the hardware processor to perform the visual damage assessment based on the one or more images comprise instructions that cause the hardware processor to perform steps comprising:
identifying, using the machine-learned model, one or more regions within the one or more images that correspond to potential damage on exterior surfaces of the vehicle; and
generating, for each identified region, a damage severity score, a damage confidence score, and a damage description, wherein the vehicle-related attributes in the structured data object include the damage severity score, the damage confidence score, and the damage description for each identified region.

14. The non-transitory computer-readable storage medium of claim 13, wherein the instructions that cause the hardware processor to cause execution of the automated action based on the structured data object comprise instructions that cause the hardware processor to perform steps comprising:
obtaining, from an external valuation service, a vehicle valuation based on a vehicle identifier included in the structured data object;
applying a damage adjustment model to the vehicle valuation based on one or more of: the damage severity score, the damage confidence score, or a number of identified damage regions; and
determining, based on an adjusted valuation output from the damage adjustment model, whether the vehicle satisfies a collateral condition.

15. The non-transitory computer-readable storage medium of claim 11, wherein the user-provided information includes a vehicle identifier, and wherein the instructions that cause the hardware processor to access, based on the user-provided information, vehicle record data from the external database system comprise instructions that cause the hardware processor to perform steps comprising:
generating an application programming interface (API) request that includes the vehicle identifier;
transmitting the API request to the external database system; and
receiving, in response to the API request, an API payload comprising the vehicle record data that includes one or more vehicle-related attributes corresponding to the vehicle identifier.

16. The non-transitory computer-readable storage medium of claim 11, wherein the instructions that cause the hardware processor to generate the validation results by comparing the extracted vehicle-related attributes with the accessed vehicle record data comprise instructions that cause the hardware processor to perform steps comprising:
comparing an extracted vehicle-related attribute with a corresponding attribute in the accessed vehicle record data;
determining, based on the comparison and a predetermined set of validation rules, whether the extracted attribute is consistent with the corresponding attribute in the vehicle record data;
generating a boolean verification flag based on a result of the determination; and
including the boolean verification flag as a validation attribute in the structured data object.

17. The non-transitory computer-readable storage medium of claim 11, wherein the structured data object is a hierarchical data structure comprising:
a first set of key-value pairs corresponding to the vehicle-related attributes extracted by the machine-learned model, the vehicle-related attributes including one or more of: a license plate number, a vehicle make, a vehicle model, a vehicle year range, a vehicle color, an odometer reading, a damage severity score, or a damage confidence score; and
a second set of key-value pairs corresponding to the generated validation results, each key-value pair in the second set representing a boolean verification flag generated based on a comparison between a corresponding value in the first set and the accessed vehicle record data.

18. The non-transitory computer-readable storage medium of claim 11, wherein the one or more images of the physical vehicle comprise:
a plurality of exterior images of the vehicle captured from front, rear, left, or right perspectives; and
an interior image of a vehicle dashboard including an odometer display.

19. The non-transitory computer-readable storage medium of claim 11, wherein the instructions that cause the hardware processor to cause execution of the automated action based on the structured data object comprise instructions that cause the hardware processor to perform steps comprising:
determining whether the vehicle satisfies eligibility criteria for use as a collateral based on one or more attributes included in the structured data object; and
triggering an approval or rejection workflow based on the determination.

20. An online system, comprising:
a hardware processor; and
a non-transitory computer-readable storage medium storing executable instructions that, when executed by the hardware processor, cause the hardware processor to perform steps comprising:
transmitting, by an online system, instructions for presenting a user interface on a client device, the user interface prompting a user of the client device to capture and upload one or more images of a physical vehicle using a camera of the client device;
receiving, at the online system, the one or more images of the physical vehicle and user-provided information associated with the vehicle;
constructing, by a preprocessing module of the online system, a multimodal input tensor comprising the one or more images, the user-provided information, and one or more structured data templates defining a schema of expected vehicle-related attributes to be extracted based on the one or more images;
providing the multimodal input tensor as input to a machine-learned model trained to extract the vehicle-related attributes from the input;
accessing, based on the user-provided information, vehicle record data from an external database system;
generating validation results by comparing the extracted vehicle-related attributes with the accessed vehicle record data;
generating a structured data object including fields corresponding to the extracted vehicle-related attributes and the generated validation results, the structured data object being encoded in a machine-readable format; and
causing execution of an automated action based on the structured data object.
